(19) United States
(12) Patent Application Publication
(10) Pub. No.: US 2008/0269980 A1
(43) Pub. Date: Oct. 30, 2008

(54) Method and System for Fuel Injector Identification and Simulation

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/109,961

(22) Filed: Apr. 25, 2008

Related U.S. Application Data
(60) Provisional application No. 60/914,528, filed on Apr. 27, 2007.

(51) Int. Cl. G01M 15/04

(52) U.S. Cl. 701/33

(57) ABSTRACT

A fuel injector simulator comprises a monitor in communication with an engine fuel injector. A pseudo fuel injector communicates with an onboard diagnostic component to present an expected fuel injector resistance value. The pseudo fuel injector determines the expected fuel injector resistance value and adjusts an adjustable output circuit to present the expected fuel injector resistance value to the onboard diagnostic component. The engine fuel injector is monitored for a fault condition. The pseudo fuel injector simulates a fuel injector fault to the onboard diagnostic component in response to a detected fault condition.

### RELATED APPLICATIONS

The present application is a Continuation-in-Part of U.S. Ser. No. 60/914,528 and it claims a priority to the provisional's Apr. 27, 2007 filing date. The present application incorporates the subject matter disclosed in ('528) as if it is fully rewritten herein.

### BACKGROUND OF THE INVENTION

1. Field of the Invention

The present invention relates to systems for the controlled combusting of fuels, and, more particularly, to internal combustion engine systems configured to operate on multiple types of fuel.

2. Background of the Invention

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control, which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

Problems arise in modifying existing conventional automobiles inj that internal combustion gasoline of diesel engines are designed to operate on fuel specifications that severely limit the possibilities of using alternative fuels, since known alternative fuel blends diverge greatly from conventional petroleum-based fuel specifications. For example, 25% more E85 is required to generate the motive power of gasoline. Thus, gasoline engine fuel injectors must be controlled to allow about 25% more E85 into engine combustion chambers to generate comparable engine performance. One way to accomplish this is by inserting a modifying device between the original equipment manufacturers' (OEM) fuel injection controllers and the fuel injectors, wherein the inserted device modifies the fuel injector pulse widths to keep the fuel injectors open longer.

This solution has its disadvantages: modern engine control systems are tightly integrated. They rely upon observation of a number of performance parameters in order to ensure proper engine performance. In particular, governmental vehicle emission standards require engine Onboard Diagnostic Systems (OBDs) to actively monitor a number of specific performance parameters for engine malfunctions that result in unacceptable increases in pollutant emissions, including fuel injector status and performance. Inserting a device between the OEM fuel injector pulse width generator and/or the OBD interferes with fuel injector monitoring, typically resulting in false fuel injector malfunction reports. In one example, due to a longer-than-expected fuel injector opening from an amplified pulse width, the OBD thinks that the fuel injector is stuck open. Breaking a direct circuit connection between the OBD and the fuel injectors may also violate governmental or other requirements.

A long need is felt for a method or a system that addresses the problems discussed above, e.g., a method that enables a conventional automobile to accept use of pulse width modifying elements without disrupting OBD monitoring of or communication with fuel injectors.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system; and,

FIG. 2 illustrates portions of an automobile fuel injector system in accordance with a preferred embodiment of the present invention.

The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

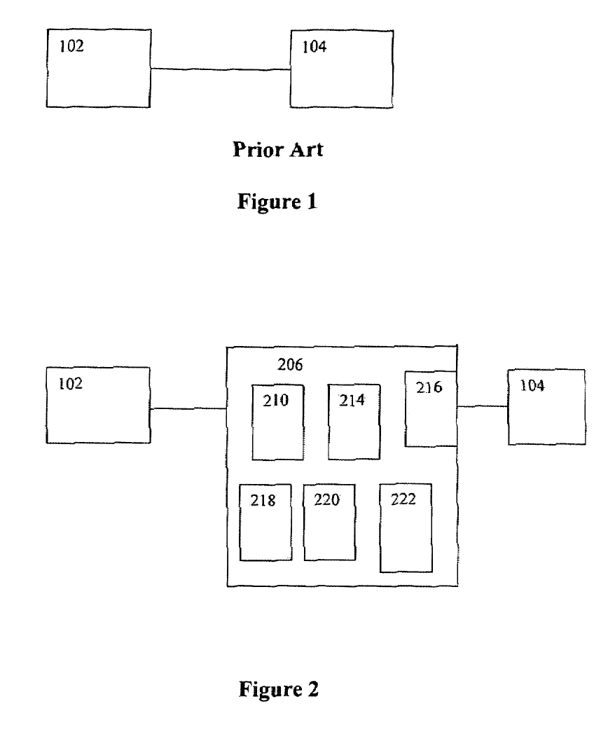

Referring now to FIG. 1, an Onboard Diagnostic System (OBD) 102 is shown in communication with and configured to control a conventional automobile fuel injector component 104. The fuel injector component 104 comprises a plurality of electronically controlled valves with at least one valve provided for each engine cylinder. The valves are each supplied with pressurized fuel by a fuel pump (not shown). The valves are configured to open and close many times per second, and the amount of fuel supplied to the engine is determined by the amount of time the fuel injector stays open. The length of time is called the “pulse width”. The pulse width signals are generated by an engine control unit (ECU, not shown).

The pulse width signals control the amount and rate of fuel injected into each engine combustion chamber, thereby controlling the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

Problems arise if the fuel injector component 104 is used with alternative fuels. For example, E85 fuel combustion generates lower energy as measured in British Thermal Units (BTUs) than gasoline fuel blends, and thus higher pulse widths are required to generate comparable engine performances under similar operating parameters. One solution is to interpose a pulse modifier element between the OBD 102 and the fuel injector component 104, in order to modify injector pulse width signals to enable the fuel injectors 104 to efficiently operate on one or more alternative fuels. For example, the pulse widths are widened for E85 or they are narrowed for alternative fuel blends having higher BTU performance characteristics relative to gasoline or diesel fuel blends; however, since, the OBD 102 is configured to monitor the fuel injectors 104 in synchronization with the OEM pulse widths, widening or shortening a pulse width may result in a fuel injector 104 being either open or closed in response to the modified pulse width when it would be in an opposite open or closed state in response to the original modified pulse width. Thus, the OBD 102 will (erroneously) report that the fuel injector 104 is in a false state, and turn on a “Check Engine” light. The injector 104 will be identified as faulty to a service scanner through an output port (not shown).

Additionally, when a pulse modifying element is physically inserted between the OBD 102 and the fuel injectors 104, direct circuit connection of OBD 102 to the fuel injectors 104 may be impeded or interrupted, preventing direct monitoring of the fuel injectors 104 for open circuit or closed circuit conditions by the OBD 102. General monitor operations of the fuel injectors 104 by the OBD 102 may be wholly preempted, and the OBD 102 will report that all of the fuel injectors 104 are in a fault state.

FIG. 2 provides an alternative fuel injector control system according to the present invention, wherein a fuel injector simulator element 206 is interposed between the OBD 102 and the fuel injector component 104. Either the injector simulator 206 or another element (not shown) modifies injector pulse width signals to enable the fuel injectors 104 to efficiently operate on one or more alternative fuels. For example, the pulse widths are widened for E85 or they are narrowed for alternative fuel blends having higher BTU performance characteristics relative to gasoline or diesel fuel blends.

The injector simulator 206 comprises a fuel injector monitor 210 configured to check the fuel injectors 104 for problems and otherwise for proper orientation relative to the modified pulse width signals, thus providing the type of OBD 102 circuit fault monitor functions required by governmental regulations. A pseudo fuel injector element 214 is also provided in direct circuit communication with the OBD 102. It is configured to appear to the OBD 102 as the fuel injectors 104. Thus, if a fault in any of the fuel injectors 104 is detected by the fuel injector monitor 210, the pseudo injector element 214 is configured to responsively appear to the OBD 102 as the one or more faulty injectors 104 in the fault condition. In one aspect, the pseudo injector element 214 is configured to appear to the OBD 102 as the fuel injector component 104 to “spoof” the behavior of the actual fuel injectors 104.

The OBD system 102 is configured to constantly monitor the fuel injectors 104 for faults. In one aspect, it monitors each of the fuel injectors 104 for open fault conditions by monitoring the electrical resistance of each fuel injector 104 and comparing it to one or more threshold values associated with each of said injectors 104. Therefore, the pseudo injector element 214 must present about the same expected resistance or range of resistance values to the OBD 102 in order to “trick” the OBD 102 into perceiving the pseudo injector element 214 as the actual fuel injectors 104 to avoid false problem reports.

Generally, different car types utilize different fuel injectors 104 having divergent electrical resistance profiles to each respective OBD 102. In order to enable the injector simulator 206 to be successfully incorporated into multiple different automobiles having divergent fuel injector 104 resistance profiles, the present embodiment further comprises a test resistor 216 located in a circuit series connection to the fuel injectors 104. A processor element 218 within or in communication with the pseudo injector 214 is configured to determine a fuel injector 104 resistance by using the test resistor 216 to measure a voltage drop and thereby calculate the injectors 104 resistance. Once the fuel injectors 104 resistance is determined, an adjustable output circuit 220 is adjusted by the processor element 218 to present the determined resistance and/or current profile. Economies of manufacturing and cost may be realized by enabling one injector simulator 206 structure to function with many divergent types of fuel injectors 104 by self-adjusting output resistance and current profiles to the OBD 102 in response to observed fuel injector characteristics.

It is generally preferred to use a test resistor 216 having a small resistance value in order to avoid impacting fuel injector 104 performance or behavior. Appropriate resistor 216 values may be readily determined by one skilled in the art. In one application of the present invention, when the injector simulator 206 is initially installed, the unit is turned on and the processor element 218 uses the test resistor 216 to measure the fuel injector's (s′) 104 resistance and save the measured value(s) in a non-volatile memory device 222 (s.a, e.g., an Electrically Erasable Programmable Read-Only Memory, or an EEPROM). The stored values remain saved in the non-volatile memory device 222 for subsequent engine operations after power down and subsequent injector simulator 206 power-ups. In another embodiment, the fuel injector(s) 104 resistance is measured and saved to the memory 222 each time the engine ignition system is energized and before the engine is started. The adjustable output circuit 220 is adjusted accordingly. In this embodiment, the memory 222 may be a volatile read-only memory (ROM) or a random-access memory (RAM) device 222.

Alternative embodiments may utilize a digital potentiometer 216 instead of the resistor 216, though this may result in higher test current demands and/or higher injector simulator 206 unit costs. In some of these embodiments, it may be preferred to locate the digital potentiometer 216 in a base power bipolar transistor circuit configured to handle higher current loads. It can still be configured in yet other embodiments for a specific fuel injector resistance of current profile, wherein the pseudo injector element 214 may have a fixed current or resistance profile. One or more of the test resistor or potentiometer 216, processor element 218 and/or memory 222 may be omitted.

The injector simulator 206 or any of its components, for example, including, the pseudo injector processor 214, may be programmed or otherwise configured by a manufacturer, an after-market retailer or installer, or by some other service provider. It may be subsequently be reprogrammed as required to provide optimal fuel settings for one or more specified alternative fuels.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Having thus described the invention what is claimed as new and desired to be secured by Letters Patent is as follows:

1. A fuel injector simulator, comprising:
a fuel injector monitor in communication with an engine fuel injector; and,
a pseudo fuel injector element in communication with an onboard diagnostic component and configured to present an expected fuel injector resistance value to the onboard diagnostic component, the onboard diagnostic component thereby configured to perceive the pseudo injector element as a fuel injector;
wherein the fuel injector monitor is configured to monitor the engine fuel injector for a fault condition and communicate the fault condition to the pseudo fuel injector element; and,
wherein the pseudo fuel injector element is configured to simulate a fuel injector fault to the onboard diagnostic component in response to a detected fault condition communicated to the fuel injector simulator by the fuel injector monitor.

2. The system of claim 1, further comprising:
a resistor detection element interposed in a circuit series connection between the pseudo injector element and the fuel injectors; and,
an adjustable output circuit;
wherein the pseudo fuel injector element is configured to use the resistor detection element to determine the expected fuel injector resistance value and to adjust the adjustable output circuit to present the expected fuel injector resistance value to the onboard diagnostic component.

3. The system of claim 2, wherein the resistor detection element is a resistor, and wherein the pseudo fuel injector element is configured to use the resistor to measure a voltage drop.

4. The system of claim 2, wherein the resistor detection element is a digital potentiometer.

5. A method, comprising the steps of:
monitoring an engine fuel injector for a fault condition;
presenting an expected fuel injector resistance value to an onboard diagnostic component, the value is presented as a fuel injector simulator output;
perceiving the fuel injector simulator output as a fuel injector output, an onboard diagnostic component perceives the outputs;
communicating a fuel injector fault condition to a fuel injector simulator in response to the step of monitoring for and detecting a fault condition; and,
simulating a fuel injector fault to the onboard diagnostic component, the fuel injector simulates the fault in response to a communicated fuel injector fault condition.

6. The method of claim 5, further comprising the steps of:
measuring a fuel injector output characteristic;
using the measured fuel injector output characteristic to determine the expected fuel injector resistance value; and,
adjusting an output circuit to present the expected fuel injector resistance value to the onboard diagnostic component.

7. The method of claim 6, wherein the step of measuring the fuel injector output characteristic comprises the steps of:
interposing a resistor between a fuel injector and the fuel injector simulator; and,
using the resister to measure a voltage drop.

8. The method of claim 6, wherein the step of measuring the fuel injector output characteristic comprises using a digital potentiometer to measure a current characteristic.
